(19) United States
(12) Patent Application Publication
(10) Pub. No.: US 2018/0329271 A1
(43) Pub. Date: Nov. 15, 2018

(54) Surface Acoustic Wave (SAW) Spatial Light Modulator Device Providing Varying SAW Speed

(71) Applicant: The Charles Stark Draper Laboratory, Inc., Cambridge, MA (US)

(72) Inventors: Ian Ward Frank, Arlington, MA (US); Dennis M. Callahan, JR., Wellesley, MA (US); Steven J. Byrnes, Watertown, MA (US); Michael Gerhard Moebius, Somerville, MA (US); Gregg E. Favalora, Bedford, MA (US)

(21) Appl. No.: 15/976,431

(22) Filed: May 10, 2018

Related U.S. Application Data
(60) Provisional application No. 62/504,799, filed on May 11, 2017.

(51) Int. Cl. G02F 1/335; G02F 1/33

(52) U.S. Cl. CPC G02F 1/335; G02F 2203/24; G02F 1/332

(57) ABSTRACT

A system and method for a Surface Acoustic Wave (SAW) spatial light modulator module, or SAW device that provides varying acoustic wave speed are disclosed. The SAW device includes a substrate of a material such as lithium niobate, and a coating layer is applied to the substrate. A SAW transducer of the device is configured to produce SAW signals that propagate with a propagation velocity around an interface between the substrate and the coating layer. The SAW signals couple light signals of a light source into modulated light signals that are emitted from the bottom face and/or edge face of the substrate. In embodiments, a frequency of RF drive signals applied to the SAW transducer in conjunction with the propagation velocity of the SAW signals produces a decrease in a SAW wavelength of the SAW signals as compared to current SAW device systems and methods.

### RELATED APPLICATIONS

This application claims the benefit under 35 USC 119(e) of U.S. Provisional Application No. 62/504,799, filed on May 11, 2017, which is incorporated herein by reference in its entirety.

### BACKGROUND OF THE INVENTION

Currently proposed autostereoscopic (naked-eye) 3D displays and, more broadly, light field generator architectures employ a variety of scanning, diffraction, space-multiplexing, steered illumination, and other techniques. One category, electro-holographic displays, relies principally on diffractive phenomena to shape and steer light. Electro-holographic light field generators hold the promise of projecting imagery with the ultimate in realism: curved optical wavefronts, which can genuinely replicate the real world. Such displays can theoretically provide nearly perfect characteristics of visual depth information, color rendering, optical resolution, and smooth transitions as the viewer changes their location. So far, displays built on this technology have not achieved this theoretical level of performance, however.

One specific device category that provides controllable sub-holograms from which a light field can be constructed uses what are known as surface acoustic wave (SAW) modulators. In these devices, a SAW is generated in a piezoelectric substrate under radio frequency (RF) excitation. This creates a time-varying diffracting region that interacts with light in waveguides formed in the substrate. In leaky mode SAW modulators, the SAW causes at least some of the light to be diffracted and change from a guided mode within the waveguides to a leaky mode that exits the waveguides, and ultimately exits the substrate

### SUMMARY OF THE INVENTION

The angle at which the light leaves the waveguides is dependent on many factors but is directly a function of the wavelength of the SAW. And the wavelength of the SAW is a function of the RF drive frequency.

As a general rule, it is desirable to decrease the RF drive frequencies. Lower frequencies are easier to generate and can he distributed within a system with lower loss and cross-talk.

The present invention concerns SAW modulators and specifically SAW modulators that have been designed to produce SAWs with shorter wavelengths at lower RF drive frequencies. This can translate to improved performance for the same RF drive frequency or the same performance with lower RF drive frequencies. In some cases, it can also increase the operational RF bandwidth of devices, where there are limitations in the maximum frequency that can be provided to the devices.

In general, according to one aspect, the invention features a Surface Acoustic Wave (SAW) modulator. It comprises a SAW substrate including an optical waveguide, a SAW transducer for generating SAWs in the SAW substrate, and a coating layer applied to a proximal face of the SAW substrate to reduce wavelengths of the SAWs.

in embodiments, the SAW transducer is patterned on top of the coating layer. In other cases, the SAW transducer is formed within the coating layer. Further, the SAW transducer can be formed in wells within the SAW substrate.

In some examples, the coating layer begins at a point downstream of the SAW transducer along the optical waveguide. It can further be applied as a strip that extends with the optical waveguide of the SAW substrate.

In general, according to another aspect, the invention features a method for manufacturing a SAW device. The method comprises depositing a coating layer upon a substrate of the SAW device to reduce a wavelength of SAW signals that travel within a waveguide and depositing an Interdigitated Transducer (IDT) for generating the SAW signals.

In general according to still another aspect, the invention features a Surface Acoustic Wave (SAW) modulator. It comprises a SAW substrate including an optical waveguide, a SAW transducer for generating SAWs in the SAW substrate, and a phononic crystal on a proximal face of the SAW substrate to reduce wavelengths of the SAWs.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a schematic side view of a SAW optical modulator with a SAW slowdown layer according to the present invention;

FIG. 2 is a schematic side view of a SAW optical modulator in which the IDT extends through the SAW slowdown layer according to another embodiment of the present invention;

FIG. 3 is a schematic side view of a SAW optical modulator in which the IDT extends through the SAW slowdown layer and into the SAW substrate according to another embodiment of the present invention;

FIG. 4 is a schematic side view of a SAW optical modulator in which the SAW slowdown layer partially covers the proximal face of the SAW substrate according to another embodiment of the present invention;

FIG. 5 is a schematic side view of a SAW optical modulator in which the SAW slowdown layer has a tapered thickness according to another embodiment of the present invention;

FIG. 6A is a schematic top view of a SAW optical modulator according to the prior art;

FIG. 6B is a schematic top view of a SAW optical modulator in which the SAW slowdown layer is strip-shaped according to another embodiment of the present invention;

FIG. 7A is a side cross-sectional view showing the extent of simulated SAW signals propagating through a portion of a SAW modulator;

FIG. 7B is a plot of SAW eigenfrequency as a function of SAW wavelength in micrometers;

FIG. 8A is a top plan view of a of lithium niobate SAW modulator with periodic pattern (“phononic crystal”) on it proximal face;

FIG. 8B is a side view with a pattern of lithium niobate discs on the proximal face of the lithium niobate SAW modulator;

FIG. 8C is a side view showing a pattern of discs made by depositing a secondary material on proximal face of the lithium niobate SAW modulator; and

FIG. 8D is a side view with a pattern of cylindrical holes etched in the proximal face of the lithium niobate SAW modulator.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

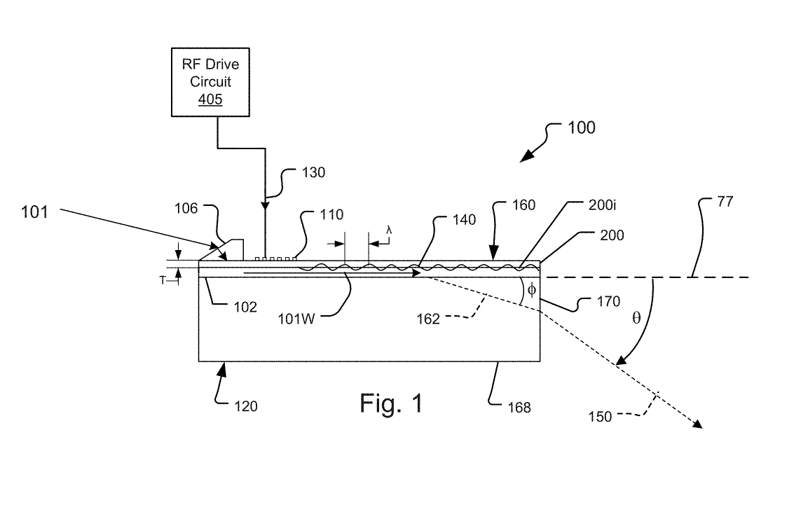

FIG. 1 shows SAW optical modulator 100. According to the invention, it includes a coating (see material coating layer 200) adjacent to waveguide 102 in the SAW substrate 120. The material coating layer is employed to change the wavelength of the surface acoustic (SAW) 140. The effect is achieved by choosing material(s) and material properties that have different SAW propagation velocities than the SAW substrate 120. In most cases, the material will have lower SAW propagation velocities, to function as a SAW slowdown layer, that will translate to shorter SAW wavelengths for the same excitation frequency.

By way of background, the SAW modulator 100 comprises the substrate 120. The substrate 120 is piezoelectric. Commonly lithium niobate is used. Other options are quartz (SiO₂), or lithium tantalate (LiTaO3). The optical substrate 120 may range in x- or y-dimensions of 1 centimeters (cm) (for near-eye display applications) to over 20 cm (for larger displays at larger viewing distances). Typically the thickness (z-dimension) of the optical substrate 120 ranges from 0.5 millimeters (mm) to 3 mm.

A waveguide 102 is formed in the SAW substrate 120. A common example is a slab waveguide formed by proton-exchange. The waveguide can be planar, ridge, rib, embedded, immersed, and bulged. Often, the waveguide 102 is formed in the substrate by doping, such as MgO-doped lithium niobate.

In general, these SAW materials exhibit a birefringence property that allows for the convenient conversion of light from the guided modes of the waveguide 102 into leaky modes that exit the waveguide. The materials also enable convenient polarization-based filtering of scattered light.

Input light 101 is coupled into the waveguide 102. An in-coupling device 106 is typically used to couple the input light 101, possibly carried in an optical fiber or propagating in freespace. Examples of in-coupling devices 106 include in-coupling prisms, gratings, or simply butt-coupling to an optical fiber. The input light 101 is launched into a guided mode upon entry into the waveguide 102. Commonly in these devices, the TE (transverse electric) mode is guided.

One or more transducers 110, e.g., interdigital transducers or IDTs, are formed on a proximal face 160 of the substrate 120. The transducers 110 are typically a patterned metal (aluminum) layer that receives drive signals 130 from an RF drive circuit 405. Titanium, gold, conductive polymers, or conductive oxides such as indium tin oxide (ITO) can also be used. Patterning the SAW transducers may be performed through photolithography (etching or lift-off), laser ablation of metal film, or direct-writing techniques.

When driven, the transducers 110 induce SAWs 140 in the substrate 120 and the material coating layer 200, The SAWs 140 propagate along the waveguide 102 and at the interface 200i between the SAW substrate 120 and the material coating layer 200.

In different embodiments, the SAW transducers 110 can occupy a variety of specific locations and specific orientations with respect to their respective waveguide 102. In the illustrated embodiment, the SAW transducers 110 are located proximate to the near end of the waveguide 102, near the in-coupling devices 106. Thus, the SAWs 140 will propagate with the direction of light propagation in the waveguide 102. Further, there could be multiple SAW transducers 110 for each waveguide 102, with each SAW transducer 110 responsible for a different specific bandwidth around a given center frequency (e.g., 100-200 MHz, 200-300 MHz, and 300-400 MHz).

In other examples, the SAW transducers 110 might be located at the opposite, far end of the waveguide 102 from the in-coupling device 106. Thus, the SAWs counter-propagate, in a direction opposite the propagation of the light in the waveguides 102.

The IDTs are designed based on the desired SAW parameters. The center to center distance between adjacent fingers of the IDT is known as the pitch of the IDT. The pitch of the IDT is typically about half of the wavelength of the SAW produced by the IDT. A typical IDT has 50-100 fingers in it, about 1-2 micrometers wide per finger. The SAW 140 is the sum of waves formed by the fingers of the IDT 110, where the waves from all fingers add in phase if the pitch is approximately equal to one-half the SAW wavelength. The SAW wavelength (λ) is defined by the propagation velocity V and the excitation frequency f, where λ/2=V/2f. The SAW signals travel down the waveguide 102 with and/or contradirectional to the light.

In operation, the light 101W in the waveguide 102 interacts with the SAW wave 140. The result of this interaction is that a portion of the guided light is diffracted and polarization-rotated, out of the guided mode and into a leaky mode having the transverse magnetic (TM) polarization. The light then exits the waveguide 102 as polarized leaky-mode or diffracted light 162 and enters substrate 120 at angle φ, measured from grazing 77. At some point this diffracted light 162 exits the substrate 120 at an exit face, which is possibly through the substrate's distal face 168, proximal face 160, or end face 170 (as shown) as exit light 150 at an exit angle of θ. The range of possible exit angles 0 comprises the angular extent, or exit angle fan, of the exit light 150.

The SAW 140 propagates on the surface of the piezoelectric substrate 120. Thus, it propagates along the interface 200i between the substrate 120 and the material coating layer 200. The constituent materials of the material layer 200 along with possibly its material stress characteristics are designed to achieve the desired relationship between the input drive frequency and the wavelength of the SAW.

To excite a range of wavelengths required to make a useful radiation shaping system from the emitted modulated light signals, such as a holographic display system, a chirped or composite IDT is often used with multiple finger pitches. The IDT will have a maximum frequency at which it can be efficiently driven as determined by its geometry and the electromechanical coupling with the underlying substrate material of the SAW device. This will lead to a minimum achievable SAW wavelength, and corresponding maximum output diffraction angle and field of view of the modulated light signals emitted from the SAW device.

In one example, the material coating layer 200 is deposited with a residual stress as a thin film on substrate 120, to further modify the SAW velocity and thus wavelength. In one example, it has a residual stress of greater than one (1) Mega Pascal (MPa). In some cases, this residual stress is compressive. In other examples it is tensile. In either case, in some examples the residual stress is even greater than 10 MPa, or higher.

The modified acoustic dispersion of the SAW signals 140 at the layer interface 200i between the coating layer 200 and the substrate 120 causes the SAW signals 140 to propagate with a reduced propagation velocity, in one embodiment. The reduced propagation velocity of the SAW signals 140 reduces their wavelength compared to a modulator without the coating layer 200.

In general, the speed of sound in a single material is related to its stiffness and inversely related to its density. At the interface, such as interface 200i, between two materials substrate 120 and coating layer 200, complex dispersive behavior can occur. The addition of the coating layer 200 changes the relationship between the driving frequencies of the RF signals 130 and the resultant SAW wavelengths A of the SAW signals 140. This is because the SAW signals 140 are now propagating around and along the interface 200i of two materials (e.g. the coating layer 200 and the substrate 120) and the propagation characteristics of the SAW signals 140 will change as a result, most importantly the propagation velocity. This change in propagation characteristics is a function of the coating material 200 and the coating layer thickness, T, and residual stress in the coating, typically.

In the preferred embodiment, due to interactions of the SAW signals 140 with both the coating layer 200 and the substrate 120, the velocity of the SAW signals 140 is decreased. With the decreased velocity of the SAW, the wavelength A of the produced SAW 140 is also decreased.

It is also important to note that there are sometimes two diffracted light beams 162, only one of which is depicted. The two beams correspond to the +1 and −1 order of diffraction when the guided optical mode 101W diffracts off the SAW 140. The device is typically designed to “filter out” one of these two beams, for example by absorbing it or sending it outside the display field-of-view.

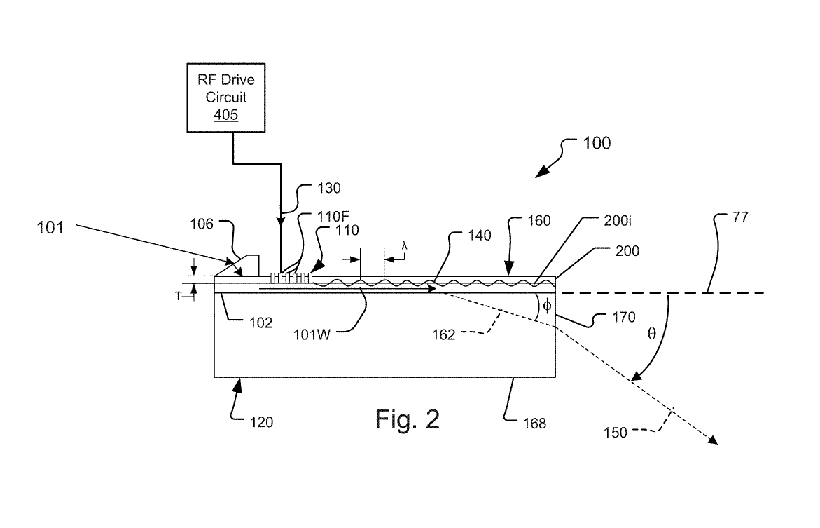

FIG. 2 illustrates another embodiment of SAW optical modulator 100. Here, the IDT 110 is formed/patterned within the coating layer 200.

In more detail, each finger 110F of the IDT 1l0 extends through the thickness T of the coating layer 200 so that it interfaces directly with the proximal face 160 of the SAW substrate 120.

This can be fabricated several ways. In one example, the MT 110 is patterned directly on the SAW substrate 120 and then the coating layer 200 is deposited on the proximal face of the SAW substrate 120. The coating layer 200 can then be polished- or etched-back in order to expose the IDT 110 for electrical connections. In other examples, the coating layer 200 is first deposited on the SAW substrate 120. It is then patterned to open up the vias through the coating layer 200 to expose the proximal face of the SAW substrate 120. The conductive material of the IDT is then deposited into these vias.

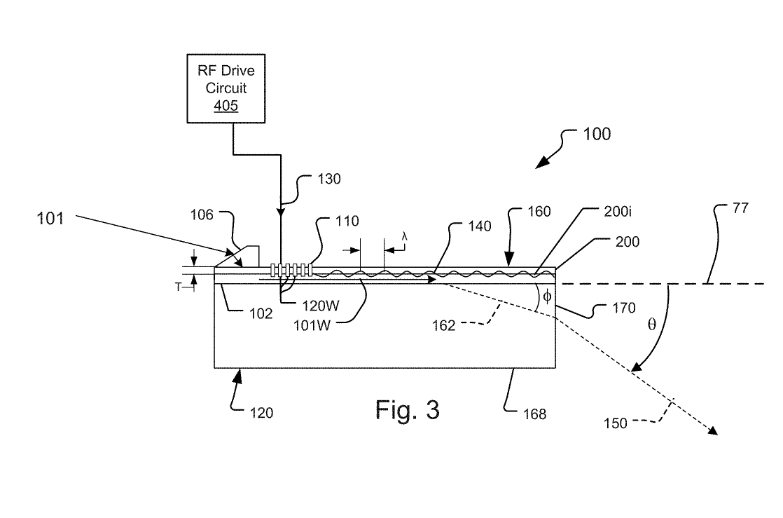

FIG. 3 illustrates another embodiment of SAW optical modulator 100. Here, the IDT 110 is formed/patterned within the coating layer 200 and extends into shallow wells 120W that have been fabricated in the proximal face of the SAW substrate 120.

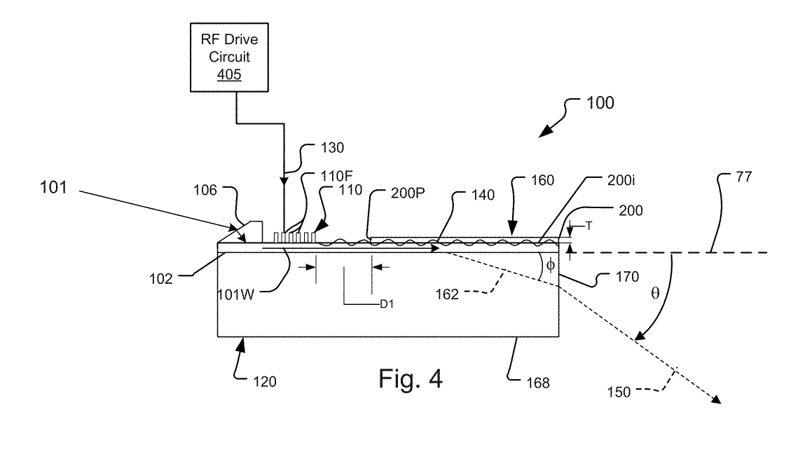

FIG. 4 shows yet another embodiment of a SAW optical modulator 100. Here, the coating layer 200 is applied only downstream from the IDT 110. Specifically, there is a distance DI between the distal end of the IDT 110 and the proximal edge 200P of the coating layer 200.

In one example, the coating layer 200 may be apodized at its proximal edge 200P to prevent acoustic and/or optical back-reflections at the interface between coated and uncoated portions of the proximal face of the substrate 120.

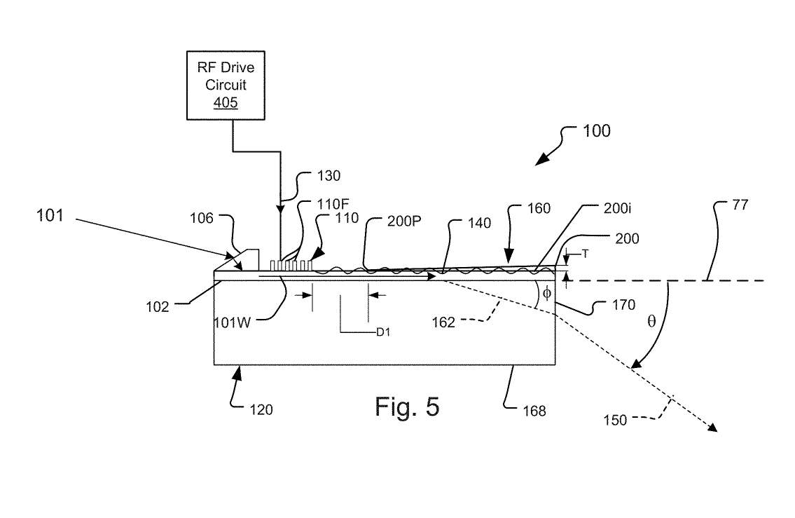

In examples, the thickness T may increase from zero gradually, compared to a wavelength, or there could be a sub-wavelength binary pattern with gradually increasing duty cycle as shown in FIG. 5.

In another example, a specially designed acoustic structure could transition the acoustic energy wave into the desired acoustic mode, somewhat analogous to the way that a long-period fiber Bragg grating switches light between modes in a different context.

In general, in the preceding embodiments, with the addition of the coating layer 200, the range of produced SAW wavelengths A change even though the IDT 110 and driving frequencies of the RF signals 130 do not. As a result, when the coating layer is designed as a SAW slowdown layer, SAW wavelengths A can be achieved that are actually smaller than the IDT pitch of the lithographically defined fingers 110F of the IDT 110. This can be useful to exceed limitations imposed by the lithographic resolution of the MT finger fabrication or maximum desired driving frequency of the RF signals 130, leading to higher achievable field-of-view's (MVO of the output light signals 150 or the ability to use lower driving frequencies of the RF signals 130 to achieve the same SAW wavelength as compared to current SAW modulators.

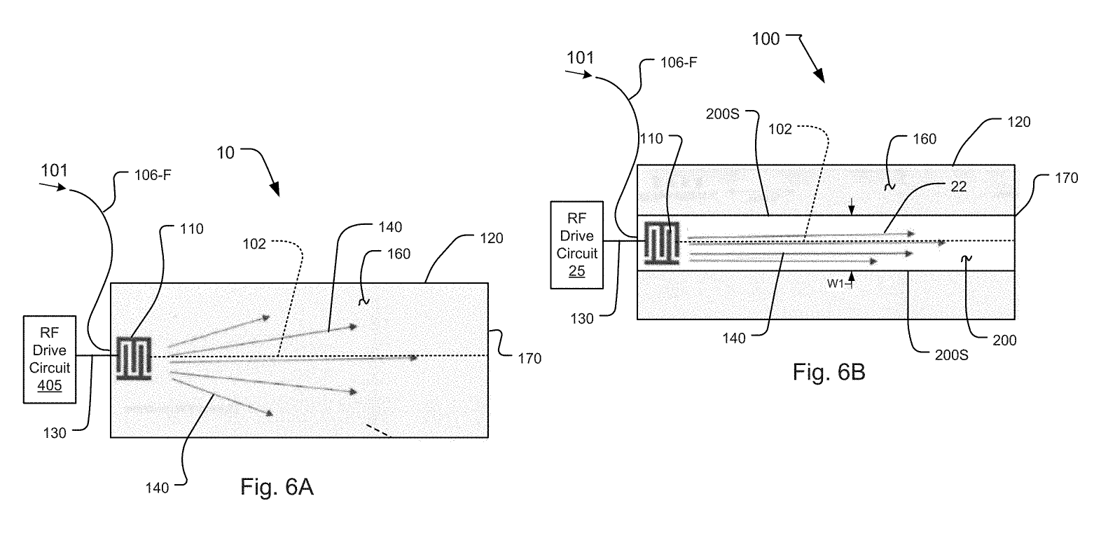

FIG. 6A shows operation of a typical prior art SAW modulator 10. As is common, the SAW signals 140 produced by the IDT 110 generally radiate outward and disperse across the proximal face 160 in a fan-like pattern. This pattern occurs despite sonic acoustic guiding. Many SAW optical modulators use an ion exchange process to create the optical waveguide 102, which thus also acts as a weak acoustic waveguide.

In some cases, the acoustic confinement afforded by the ion exchange process may not be enough to properly confine the SAW 140, particularly if the waveguides 102 were intended to support a single optical mode. This means that their size will be scaled to the wavelength of light in the substrate rather than the wavelength of the SAWs. Because the SAWs of current SAW devices often lack lateral confinement, the SAWs 22 diffract as they propagate down the length of the waveguide 102 and across the substrate 120. The unconfined propagation of the SAWS 140 induces diffraction which is a function of the SAW wavelength and the aperture size of the IDT 110.

This effect correspondingly reduces overlap between the SAWs 140 and the underlying optical modes of the light 101W in the waveguide 102. This thus reduces the coupling efficiency of the light 101W into the leaking modes to form the diffracted light beam 162,

FIG. 6B shows operation of yet another embodiment of a SAW modulator 100 constructed in accordance with principles of the present invention.

Here, coating layer 200 is patterned. The patterning process can be performed either while or after it is deposited on the proximal face 160 of the SAW substrate 120. The coating layer 200 is applied to the proximal face 160 of the substrate 120 in a strip-like fashion, extending longitudinally along the device 100 and having side walls 200s aligned and running parallel with the waveguide 102. Because the coating layer 200 is patterned on top of the ion exchanged waveguide 100, the coating layer 200 further improves the acoustic confinement of the SAW 140 and allows efficient guiding of the SAW 140.

In more detail, if the surface coating 200 is patterned in a lateral direction and continuous in the direction of propagation of the SAW 140 in one example, diffraction of the SAW 140 can be significantly reduced, This leads to a more confined strain field and therefore more efficient overlap between the SAW 140 and the optical modes of the light 101W propagating in the waveguide 102. Preferably, the dispersion of the SAW 140 is flat so that it does not become distorted as it propagates along the waveguide 102 and across the device 100.

In the preferred embodiment, the width W1 of the coating layer 200 in the lateral direction of the device 100 is about 0.5λ or one half the wavelength of the SAW, or greater.

Yet another way to guide the SAW 140 is to etch a ridge into the SAW substrate 120 and excite the SAW along the ridge. This can also provide lateral guidance of the SAW 140, due to the fact that the SAW 140 in the substrate 120 having the etched ridge cannot propagate in air.

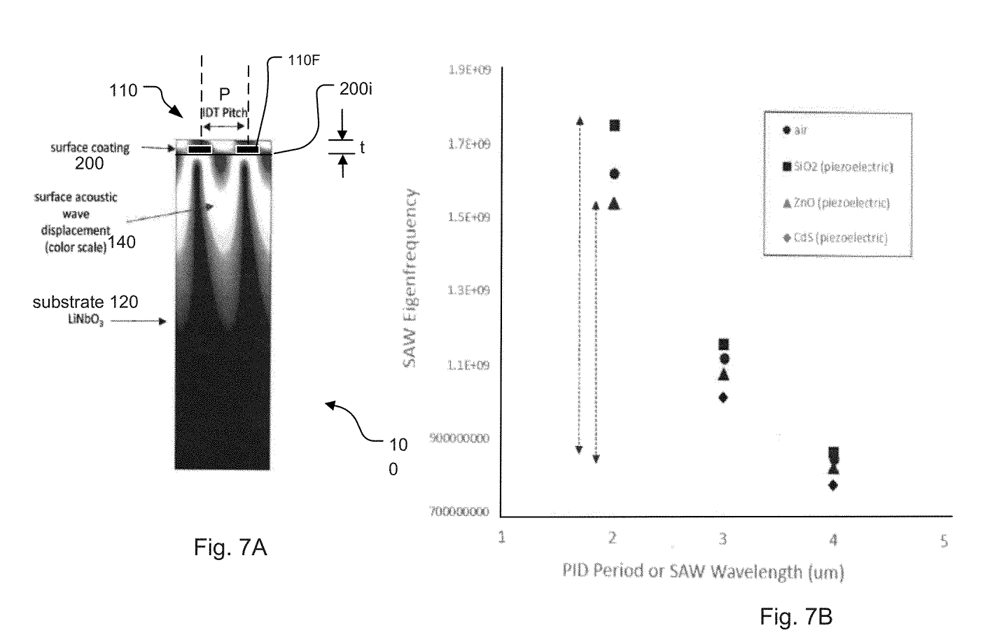

FIG. 7A shows simulated SAW 140 propagating through a portion of a SAW substrate 120 of a SAW modulator 100 constructed in accordance with principles of the present invention. The scale displacement was created using the commercial software package COMSOL Multiphysics (COMSOL). COMSOL is a registered trademark of COMSOL, Inc.

In the simulations, a coupled model that simulates both solid mechanics and electrostatics was used to calculate the eigenfrequency of exemplary SAWs 140 excited by an IDT 110 on a LiNbO₃ substrate 120 that is coated with coating layers 200 of various materials. Also in these simulations, the SAW wavelength is defined by the pitch P of the fingers 110F of the IDT 110. The simulation calculates the frequency needed to excite a wave of SAW 140 for each material. In this way, the IDT finger pitch P can be varied in accordance with the sound characteristics of each material selected as the coating layer 200.

Based on initial considerations and simulations, materials for the coating layer 200 that can be used to modify the propagation characteristics of SAW 140 include but are not limited to SiO₂, ZnO, CdS, lead zirconium titanate (PZT), Si3N4, SiC, Al₂O₃, poly methyl methacrylate (PMMA), amorphous fluoropolymers such as Cytop, and polydimethylsiloxane (PDMS), in examples.

Another way to form the coating layer 200 is to proton or ion implant the proximal face 160 of the substrate 120. In other examples, a separate coating layer could be deposited on the SAW substrate 120 and then that layer is proton or ion implanted.

FIG. 7B shows plots of SAW excitation frequency (i.e. eigenfrequency) versus SAW wavelength λ for the coating layers 19 of different materials described previously. The plots show that the SAW wavelength-SAW frequency relationship changes with different materials used as the thin film coating layer 200.

It can also be appreciated that another way to change the propagation characteristics of SAW signals 22 would be to use materials other than lithium niobate (LiNbO₃) as the substrate 120. Materials other than lithium niobate can provide different SAW frequency and wavelength, where the propagation characteristics of SAW 140 in these materials are altered by the same ion exchange process that is currently used to form waveguides 102 in lithium niobate substrates 120. However, the characteristics of waveguides formed by these substrates and the optical mode characteristics of light signals traveling within waveguides constructed from these materials are likely non-desirable.

It can also be appreciated that the SAW 140 can also be confined by placing a phononic and/or photonic crystal on either side of the optical waveguide 102. A photonic crystal defines propagation of light, where a phononic crystal (e.g. piezoelectric/acoustic metamaterial) defines propagation of sound waves. If the optical wave is much more tightly confined, the structure of a phononic crystal likely will not impact wave propagation. For this purpose, using different materials to define the acoustic wave propagation would be possible with minimal impact on the optical wave in the waveguide 102. The improved confinement of the SAW 140 provided by the placement of the photonic and/or phononic crystals on the substrate 120, in turn, can enable the production of smaller SAW wavelengths for the same RF signal 130/frequency input applied to the DT 110 of the SAW modulator 100.

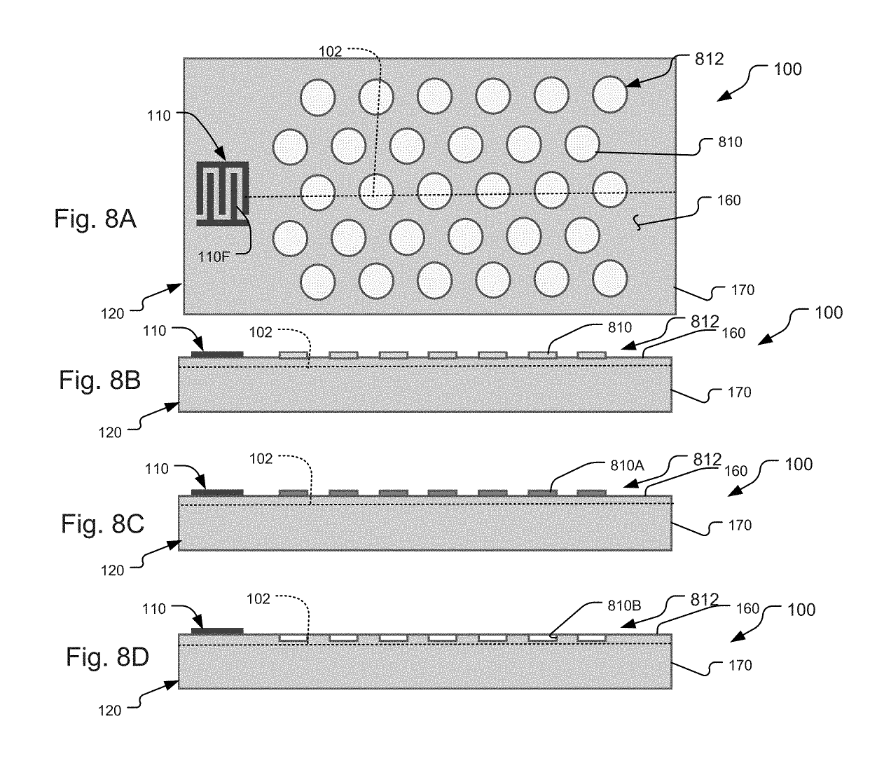

FIG. 8A shows lithium niobate SAW modulator 100 with periodic pattern 812 (“phononic crystal”) on it proximal face 160. Specifically, there is a periodic pattern 812 of disks 810 of the phononic crystal. These are used to confine the SAW that is generated by the IDT 110 as it propagates along the waveguide 102.

FIG. 8B is a side view with a pattern 812 of lithium niobate discs 810 on the proximal face of the lithium niobate SAW modulator 100. In this embodiment, the discs 810 are made of lithium niobate. They can be fabricated by etching back the proximal face 160 of the substrate 120 of the modulator 100. Other embodiments can be grown, such as epitaxy grown, on the proximal face 160.

FIG. 8C is a side view showing a pattern 812 of discs 810A made by depositing a secondary material on proximal face 160 of the substrate 120 of the lithium niobate SAW modulator 100.

FIG. 8D is a side view with a pattern 812 of cylindrical holes 810B etched in the proximal face 160 of the substrate of the lithium niobate SAW modulator 100.

Because LiNbO₃ has a fairly high refractive index, ridge waveguides etched out of a thin film will have very high core confinement, meaning the optical wave will sample the birefringence and nonlinear properties of LiNbO₃. If thin-film, single-crystalline LiNbO₃ is used, it will have the same material properties as bulk LiNbO₃. The thin layer of LiNbO₃, in one example, could be epitaxially grown on base substrate or transferred to a wider variety of substrates with desired acoustic properties. The more weakly confined acoustic wave could sample more of the substrate and/or cladding material, allowing the choice of surrounding materials to dictate the acoustic wave speed/dispersion. Waveguides made from thin film LiNbO₃ could have the added benefit of enabling greater overlap between the guided optical and acoustic waves. Because the coating layer has different acoustic properties than that of the substrate, the SAWs can propagate with a reduced propagation velocity at the interface 200i between the substrate and the coating layer.

Finally, an approach less related to materials science and more associated with principles of optics could be used to decrease the SAW wavelength of SAW 140 produced in SAW modulators 100. In this approach, because the SAWs can exist in a waveguide 102 that is substantially larger than an optical waveguide, an acoustic analog of a photonic crystal (e.g. a phononic crystal) can be designed to produce something similar to a “slow light” region within the waveguide 102 for the SAW Because the propagation velocity of the SAW 140 is reduced in these slow light regions, the wavelength of the SAW 140 decreases. Drawbacks to this approach include fabrication of very small-scale structures (smaller than the acoustic wavelength) to produce the slow light regions, and the structures would likely function best in a narrow band of frequencies and could introduce some complicated dispersion. Structures for producing the slow light regions can include periodically arranged posts or patches or differing materials, in one example.

While this invention has been particularly shown and described with references to preferred embodiments thereof, it will be understood by those skilled in the art that various changes in form and details may be made therein without departing from the scope of the invention encompassed by the appended claims.

What is claimed is:

1. A Surface Acoustic Wave (SAW) modulator, comprising:
a SAW substrate including an optical waveguide;
a SAW transducer for generating SAWs in the SAW substrate; and
a coating layer applied to a proximal face of the SAW substrate to change wavelengths of the SAWs.

2. The system of claim 1, wherein the SAW transducer is patterned on top of the coating layer.

3. The system of claim 1, wherein the SAW transducer is formed within the coating layer.

4. The system of claim 1, wherein the SAW transducer is formed in wells within the SAW substrate.

5. The system of claim I, wherein the coating layer begins at a point downstream of the SAW transducer along the optical waveguide.

6. The system of claim 1, wherein the coating layer is applied as a strip that extends with the optical waveguide of the SAW substrate.

7. The system of claim 1, wherein the SAW transducer is formed at least within the coating layer and optionally also within the substrate.

8. The system of claim 1, further comprising at least one phononic crystal placed on a side of the waveguide of the substrate to confine the SAW signals within the waveguide.

9. The system of claim 1, wherein the SAWs propagate along an interface between the coating layer and the SAW substrate.

10. The system of claim 1, wherein the coating layer reduces wavelengths of the SAWS.

11. A Surface Acoustic Wave (SAW) modulator, comprising:
a SAW substrate including an optical waveguide;
a SAW transducer for generating SAWs in the SAW substrate; and
a phononic crystal on a proximal face of the SAW substrate to reduce wavelengths of the SAWs.

12. A method for manufacturing a SAW device, the method comprising:
depositing a coating layer upon a SAW substrate of the SAW device to change a wavelength of SAWs that travel within a waveguide of the SAW substrate; and
forming a SAW transducer for generating the SAWs; and
generating the SAWs that propagate along an interface of the coating layer.

13. The method of claim 12, wherein the SAW transducer is patterned on top of the coating layer.

14. The method of claim 12, wherein the SAW transducer is formed within the coating layer.

15. The method of claim 12, wherein the SAW transducer is formed in wells within the SAW substrate.

16. The method of claim 12, wherein the coating layer begins at a point downstream of the SAW transducer along the optical waveguide.

17. The method of claim 12, wherein the coating layer is applied as a strip that extends with the optical waveguide of the SAW substrate.

18. The method of claim 12, further comprising forming the SAW transducer within the coating layer and optionally also within the substrate.

19. The method of claim 12, wherein the coating layer reduces wavelengths of the SAWs.

20. A method for fabricating a Surface Acoustic Wave (SAW) modulator, comprising:
forming a waveguide in a SAW substrate;
forming a SAW transducer for generating SAWs in the SAW substrate; and
forming a phononic crystal on a proximal face of the SAW substrate to reduce wavelengths of the SAWs.
